(19) United States
(12) Patent Application Publication
(10) Pub. No.: US 2018/0129944 A1
(43) Pub. Date: May 10, 2018

(54) DOCUMENT UNDERSTANDING USING CONDITIONAL RANDOM FIELDS

(71) Applicant: Xerox Corporation, Norwalk, CT (US)

(72) Inventors: Jean-Luc Meunier, Saint-Nazaire-les-Eymes (FR); Hervé Déjean, Grenoble (FR)

(73) Assignee: Xerox Corporation, Norwalk, CT (US)

(21) Appl. No.: 15/344,771

(22) Filed: Nov. 7, 2016

(51) Int. Cl. G06N 5/04; G06N 99/00; G06F 17/30

(52) U.S. Cl. CPC G06N 5/04; G06F 17/30011; G06N 99/005

(57) ABSTRACT

A multi-page document is represented as a graph in which extracted page objects of the document, such as text blocks, are represented by nodes that are connected by intra-page edges and/or cross-page edges. The nodes and edges of the graph are associated with respective sets of features, the edge features distinguishing between intra-page and cross-page edges. A trained first model jointly predicts class labels for page objects, based on node and edge features. Page labels for the pages may be predicted, based on the page object predictions, optionally enforcing a constraint, such a maximum of one class label for a given class, per page. The pages can be assigned a respective category, based on the predicted classes of the page objects and respective features. Information based on the predictions is output, such as one or more of the page object class labels, the page labels, and information based thereon.

### BACKGROUND

Aspects of the exemplary embodiment relate to automated systems and methods for analysis of document structure and find particular application in the context of indexing project plans.

Project plans for a construction project, such as a building, bridge, or device, which may be referred to as working drawings or blueprints, are often specialized by discipline, such as electrical, plumbing, landscaping, and so forth. These plans may be assembled in a sequence to create a document in which each page of the document is a respective plan. Such project documents are often stored electronically in an unstructured format, and thus the reader may need to search the document manually to find a relevant plan for his or her discipline. Indexing of project documents is often omitted since it is a time-consuming, manual task.

Automated methods for determining logical document structure have been used to extract information, such as page numbers, titles and so forth, from pages of a document, such as a scanned book, which may be used to generate a table of contents. However, project plans do not lend themselves to document processing with existing techniques. The discipline of a plan, for example, may not be specified in the textual content of the page. Numbering of the plans may not be consecutive in the document and may follow a proprietary numbering scheme.

There remains a need for an automated system and method for extracting the plan-title, plan-number, and the discipline of each plan of a document, composed of a sequence of plans which enables the documents to be indexed or more readily searched.

### INCORPORATION BY REFERENCE

The following references, the disclosures of which are incorporated herein by reference in their entireties, are mentioned:

U.S. Pub. No. 20060271847, published Nov. 30, 2006, entitled METHOD AND APPARATUS FOR DETERMINING LOGICAL DOCUMENT STRUCTURE, by Jean-Luc Meunier; U.S. Pub. No. 20080025608, published Jan. 31, 2008, entitled LANDMARK-BASED FORM READING WITH DECLARATIVE LANGUAGE, by Jean-Luc Meunier; U.S. Pub. No. 20080065671, published Mar. 13, 2008, entitled METHODS AND APPARATUSES FOR DETECTING AND LABELING ORGANIZATIONAL TABLES IN A DOCUMENT, by Hervé Déjean, et al.; U.S. Pub. No. 20080077847, published Mar. 27, 2008, entitled Captions detector, by Hervé Déjean; U.S. Pub. No. 20080114757, published May 15, 2008, entitled VERSATILE PAGE NUMBER DETECTOR, by Hervé Déjean et al.; U.S. Pub. No. 20100306260, published Dec. 2, 2010, entitled NUMBER SEQUENCES DETECTION SYSTEMS AND METHODS, by Hervé Déjean; U.S. Pub. No. 20110225490, published Sep. 15, 2011, entitled DOCUMENT ORGANIZING BASED ON PAGE NUMBERS, by Jean-Luc Meunier; U.S. Pub. No. 20110145701, published Jun. 16, 2011, entitled METHOD AND APPARATUS FOR DETECTING PAGINATION CONSTRUCTS INCLUDING A HEADER AND A FOOTER IN LEGACY DOCUMENTS, by Hervé Déjean et al.; U.S. Pub. No. 20120079370, published Mar. 29, 2012, entitled SYSTEM AND METHOD FOR PAGE FRAME DETECTION, by Hervé Déjean; U.S. Pub. No. 20130321867, published Dec. 5, 2013, entitled TYPOGRAPHICAL BLOCK GENERATION, by Hervé Déjean; U.S. Pub. No. 20120324341, published Dec. 20, 2012, entitled DETECTION AND EXTRACTION OF ELEMENTS CONSTITUTING IMAGES IN UNSTRUCTURED DOCUMENT FILES, by Hervé Déjean; U.S. Pub. No. 20130343658, published Dec. 26, 2013, entitled SYSTEM AND METHOD FOR IDENTIFYING REGULAR GEOMETRIC STRUCTURES IN DOCUMENT PAGES, by Hervé Déjean; U.S. Pub. No. 20140212038, published Jul. 31, 2014, entitled DETECTION OF NUMBERED CAPTIONS, by Hervé Déjean, et al.; U.S. Pub. No. 20140365872, published Dec. 11, 2014, entitled METHODS AND SYSTEMS FOR GENERATION OF DOCUMENT STRUCTURES BASED ON SEQUENTIAL CONSTRAINTS, by Hervé Déjean; U.S. Pub. No. 20150026558, published Jan. 22, 2015, entitled PAGE FRAME AND PAGE COORDINATE DETERMINATION METHOD AND SYSTEM BASED ON SEQUENTIAL REGULARITIES, by Hervé Déjean; U.S. Pub. No. 20150169510, published Jun. 18, 2015, entitled METHOD AND SYSTEM OF EXTRACTING STRUCTURED DATA FROM A DOCUMENT, by Hervé Déjean, et al.; U.S. Pub. No. 20150178256, published Jun. 25, 2015, entitled METHOD AND SYSTEM FOR PAGE CONSTRUCT DETECTION BASED ON SEQUENTIAL REGULARITIES, by Hervé Déjean; U.S. Pub. No. 20160063322, published Mar. 3, 2016, entitled METHOD AND SYSTEM OF EXTRACTING LABEL:VALUE DATA FROM A DOCUMENT, by Hervé Déjean, et al.; U.S. Pub. No. 20150095022, published Apr. 2, 2015, entitled LIST RECOGNIZING METHOD AND LIST RECOGNIZING SYSTEM, by Canhui Xu, et al.; U.S. Pub. No. 20150093021, published Apr. 2, 2015, entitled TABLE RECOGNIZING METHOD AND TABLE RECOGNIZING SYSTEM, by Canhui Xu, et al.; and U.S. Pat. No. 7,720,830, published May 18, 2010, entitled HIERARCHICAL CONDITIONAL RANDOM FIELDS FOR WEB EXTRACTION, by Ji-Rong Wen, et al.

### BRIEF DESCRIPTION

In accordance with one aspect of the exemplary embodiment, a method for processing a multi-page document includes providing a trained first model for jointly predicting class labels for page objects of pages of a document, the predicted class labels being selected from a predefined set of class labels. A multi-page document to be labeled is received. A graph is generated in which page objects extracted from pages of the multi-page document are represented by nodes that are connected by edges. The nodes and edges of the graph are each associated with a set of features. The edges include intra-page edges and cross-page edges. With the trained first model, object class labels are jointly predicted, from the set of class labels, for at least some of the represented page objects, the prediction being based on the sets of features of the nodes and edges. Information based on the predicted object class labels is output.

At least one of the generation of the graph and predicting object class labels is performed with a processor.

In accordance with another aspect of the exemplary embodiment, a system for processing a multi-page document includes a graphing component which generates a graph in which page objects extracted from pages of a multi-page input document are represented by nodes that are connected by edges, the nodes and edges of the graph each being associated with a set of features. The edges include intra-page edges and cross-page edges. An object class label prediction component with access to a trained first model, is stored in memory, for jointly predicting object class labels for page objects of the pages of the input document, based on the graph. Optionally, a page class label prediction component computes a confidence score for page objects with respect to the page object class labels, and for pages of the input document, assigns a respective at least one page label, based on the confidence scores. Optionally, a category prediction component, with access to a trained second model, stored in memory, which predicts, for pages of the input document, a respective category from a predefined set of categories, based on at least one of the predicted object class labels and predicted page labels. An output component outputs information, based on the predicted page labels of pages of the input document. A processor implements the components.

In accordance with another aspect of the exemplary embodiment, a method for generating a system for processing a multi-page document includes, with a processor, training a first model for jointly predicting class labels for text blocks of pages of a document. The predicted class labels are selected from a predefined set of class labels including a page title label and a page number label using a cyclic graph generated for the document. The first model is stored in memory. Instructions are provided in memory for generating the cyclic graph. In the cyclic graph, text blocks extracted from pages of the multi-page document are represented by nodes that are connected by edges. The nodes and edges of the graph are each associated with a respective set of features. The edges include intra-page edges and cross-page edges. Instructions are provided in memory for predicting, for each page of the input document, a maximum of a single page title and a maximum of a single page number. With a processor, a second model is provided for predicting discipline labels for pages of the document, based on the predicted page titles and page numbers for the document and the second model stored in memory. Instructions are provided for outputting information based on the predicted page titles, page numbers, and discipline labels of the pages of the document.

### BRIEF DESCRIPTION OF THE DRAWINGS

FIG. 1 is a functional block diagram of a system for processing multi-page project documents, in accordance with one aspect of the exemplary embodiment;

FIG. 2 is a flow diagram illustrating a method for processing multi-page project documents, in accordance with another aspect of the exemplary embodiment;

FIG. 3 is a flow diagram illustrating generation of a document-level graph in the method of FIG. 2;

FIG. 4 illustrates a project plan of an exemplary project document;

FIG. 5 illustrates a graph of a project document with intra-page and cross-page edges connecting nodes representing text boxes;

FIG. 6 schematically illustrates intra-page and cross-page edges between blocks; and

FIG. 7 schematically illustrates text blocks of a project plan, only some of which are connected by edges.

### DETAILED DESCRIPTION

A system and method for processing a document that includes a sequence of pages, such as project plans, are described. The exemplary processing predicts class labels (referred to as object classes), for page objects, such as text blocks, identified in the document pages. The exemplary object classes include a page title class (the page object is predicted to include the title of the respective page) and a page number class (the page object is predicted to include the number of the respective page). Based on the predicted object classes for the page objects, page-level class labels (referred to herein as page labels), such as the page title and page number, and a category (e.g., discipline) of pages of the sequence of pages forming the document are predicted. In the case of a project document, each plan corresponds to a respective page of the document.

In one embodiment, the system and method predict the object classes in the document jointly, using a first classifier, such as a Conditional Random Field (CRF) classifier. A confidence model may be used to predict at maximum, a single page-level label for the plan title and a single page-level label for the plan number, based on the classes predicted for the page objects by the first classifier. A page category, such as the plan discipline, is subsequently predicted with a second classifier, such as a sequential CRF classifier, using the set of predicted plan titles and plan numbers for the document.

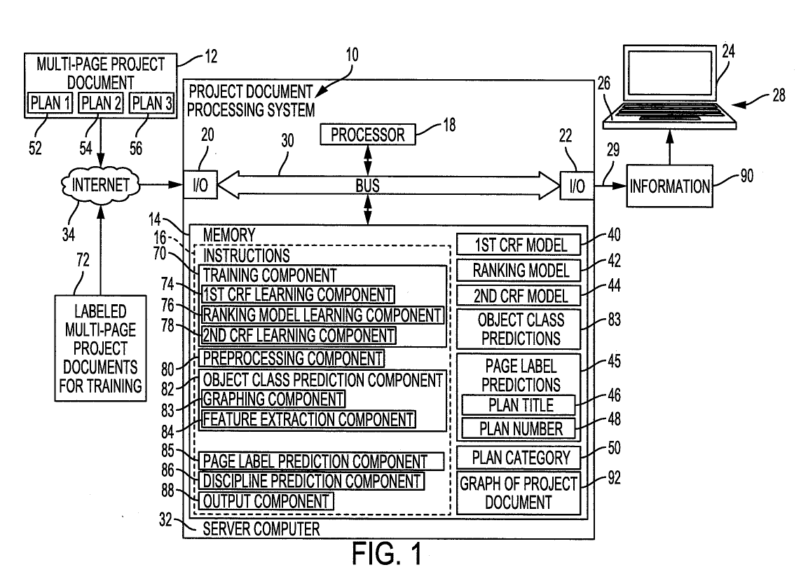

With reference to FIG. 1, a system 10 for processing a multi-page document 12 is illustrated. While particular reference is made to processing of project documents containing a sequence of plans, it is to be appreciated that other documents with multiple pages can be considered.

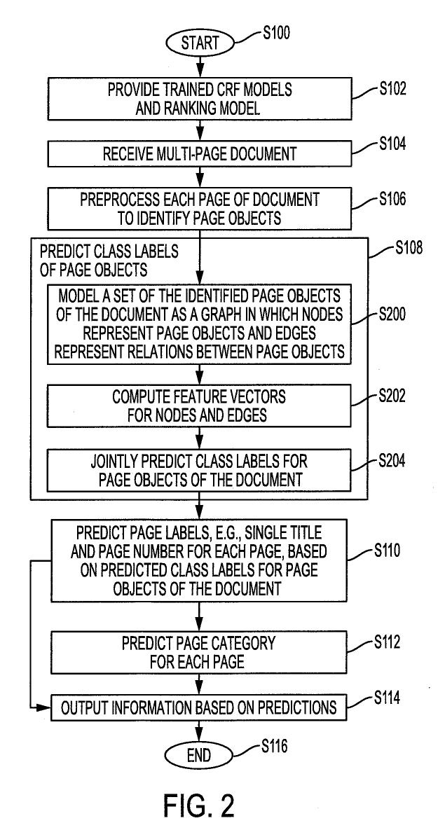

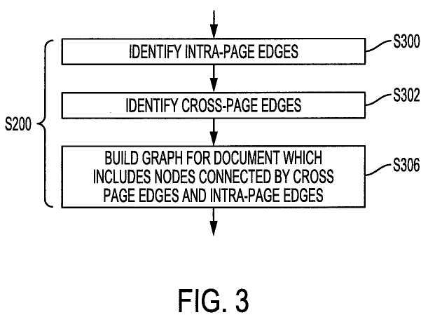

The illustrated computer-implemented system 10 includes memory 14 which stores software instructions 16 for performing the method illustrated in FIGS. 2 and 3 and a processor device 18 in communication with the memory for executing the instructions. The system 10 also includes one or more input/output (I/O) devices, such as a network interface 20 and a user input output interface 22. The I/O interface 22 may communicate with one or more of a user output device, such as a display 24 or speakers, for displaying or otherwise outputting information to users, and a user input device 26, such as a keyboard or touch or writable screen, and/or a cursor control device, such as mouse, trackball, or the like, for inputting text and for communicating user input information and command selections to the processor device 18. The user output and/or input devices may form part of a client device 28, which is connected with the system by a wired or wireless link 29, as illustrated, or may be directly connected with the system. The various hardware components 14, 18, 20, 22 of the system 10 may all be connected by a data/control bus 30.

The computer system 10 may include one or more computing devices 32, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 14 may represent any type of non-transitory computer readable medium such as random access memory (RAM), read only memory (ROM), magnetic disk or tape, optical disk, flash memory, or holographic memory. In one embodiment, the memory 14 comprises a combination of random access memory and read only memory. In some embodiments, the processor 18 and memory 14 may be combined in a single chip. Memory 14 stores instructions for performing the exemplary method as well as the processed data.

The interface 20, 22 allows the computer to communicate with other devices via wired or wireless links 29, 34, for example, a computer network, such as a local area network (LAN) or wide area network (WAN), or the Internet, and may comprise a modulator/demodulator (MODEM) a router, a cable, and/or Ethernet port.

The digital processor device 18 can be variously embodied, such as by a single-core processor, a dual-core processor (or more generally by a multiple-core processor), a digital processor and cooperating math coprocessor, a digital controller, or the like. The digital processor 18, in addition to executing instructions 16 may also control the operation of the computer 32.

The exemplary system 10 stores, or has access to, an object classification model 40, such as a first CRF classifier model, a ranking model 42, and a category classification model, such as a second CRF classifier model 44, which are used in predicting page labels 45, such as a plan title 46, a plan number 48, and a page category, such as a plan discipline 50, for each of, or for at least some of, the plans 52, 54, 56, etc. in the input project document 12. While a sequence of three plans is illustrated by way of example, it is to be appreciated that a typical project document 12 may have many more plans (pages), such as at least 5, or at least 10, or at least 20 plans. In the case of project documents, a plan and a page have the same meaning.

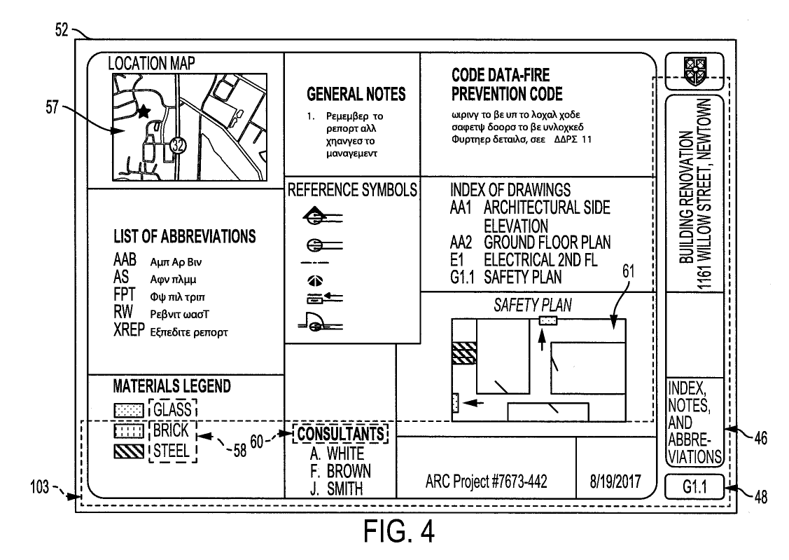

As shown in FIG. 4, which illustrates a simplified plan 52 of a multi-page project document, the plan title 46 is a human-readable description of the specific plan 52, here “Index, notes, and abbreviations.” In general, each plan of a project document has a unique title 46. The plan number 48 is generally a sequence of one or more symbols (e.g., letters, numbers, punctuation, or a combination thereof) from a predefined alphabet of symbols, which is intended to uniquely identify the plan. In general, at least part of the plan number is part of a sequence, such as a sequence of numbers (1.1, 1.2, etc.), letters, Roman numerals, combination thereof, or the like. The discipline 50 of each plan of the project document generally does not appear explicitly on the document, but is assumed to be one of a finite set of plan disciplines, such as three, five, or more disciplines, or up to twenty disciplines, each corresponding to a different type of plan. As an example, there may be a predefined set of disciplines including some or all of Architectural, Civil, Electrical, Landscape, Mechanical, Plumbing, Other, Structural, and Title page, which may be represented by the unique letters A, C, E, L, M, P, O, S, and T. These letters (or other unique discipline symbols) may occur as part of the plan number, in some cases. For example, electrical plan numbers 48 may all include the discipline symbol E, e.g., as the first symbol, which may be followed by one or more sequence symbols (such as E1.1 for the first electrical plan, E1.2 for the second, and so forth). However, a project document creator is not limited to using these specific symbols in the plan number.

It is to be appreciated that the page-level label predictions 46, 48 need not include a predicted plan title and a predicted plan number, but may additionally, or alternatively, include predictions of other page-level labels.

As will be evident from the illustrative plan 52, the page content can be considered as a set of page objects, such as image objects 57, textual objects 58, 60, vector graphic objects 61, tables, combination thereof, or the like. For some or all of the pages in a document, each page object includes less than all of the content of the respective page. In the following, particular reference is made to text objects, which can be extracted as regularly-shaped text blocks 58, 60. However, it is to be appreciated that other page objects can be considered.

The text content of the page can include different fonts, font sizes, bold, italic, etc. This information may be used in ascribing features to text blocks 58, 60, etc. which can be extracted from the document. Each text block includes a sequence of text in a natural language having a grammar, such as English or French. Each text block is defined by a bounding box (shown by dashed lines) which is the smallest rectangle that encompasses all of the text of the particular text block. The text in a given block may be aligned horizontally (typically left to right in English), top-down vertically, or bottom-up vertically.

Returning to FIG. 1, the instructions 16 include a training component 70 for training the models 40, 42, 44 using labeled training data 72, such as a collection of manually-labeled project documents. The collection 72 may include at least ten or at least fifty or at least one hundred documents, and/or at least 1000 or at least 5000 plans/pages in total. The illustrated training component 70 includes separate components 74, 76, 78 for training the respective models 40, 42, 44. As will be appreciated, one or more of the models 40, 42, 44 may be trained elsewhere, in which case, the training component 70 may be omitted or modified.

A preprocessing component 80 receives an input project document 12 (or training project document 72) and segments the document to generate a set of text blocks 58, 60, etc. for each plan 52, 54, 56, etc. Each extracted text block is associated with spatial information, identifying its position on a respective plan, and textual information, such as identified characters, font style and size, etc. The number of text blocks per page is not limited, but for at least some pages, some of the text blocks may include at least two lines of text. As an example, in a given document, for a plurality of plans at least two or at least three text blocks are identified in at least a preselected region of the plan.

At prediction time, given a preprocessed project document 12, an object class prediction component 82 predicts, for each (or at least some) of the extracted objects, e.g., for text blocks 58, 60, an object class 83, using the first CRF model 40. The object class prediction 83 may be a single class for the object, from a finite set of classes, or a distribution over all classes. The exemplary classes include a plan title class, a plan number class, and an “other” class, for blocks not assigned to the plan title class or plan number class. The exemplary prediction component 82 includes a graphing component 83, which generates a graph for at least some of the extracted text blocks (and/or other extracted page objects), and a feature extraction component 84, which extracts features of edges and nodes of the graph, which are input to the first CRF model 40. The exemplary edge features distinguish between intra-page and cross-page edges.

A page prediction component 85 predicts, for each plan of the project document (or for each of at least some of the plans), one or more page labels, such as a page title 46 and/or a page number 48, using the ranking model 42. The prediction is based on the object-level class predictions 83, e.g., derived from the text of a text block on the page that is labeled with a respective class. In one embodiment, the page prediction component 85 predicts for each page, at maximum, a single plan title 46 and a single plan number 48. For example, the prediction component 85 computes a confidence score for text blocks with respect to the predicted page title and page number classes, and for each page of the input document, assigns a maximum of a single page title and a maximum of a single page number, based on the confidence scores. In one embodiment, this functionality is incorporated into the graphical CRF model 40, e.g., with a potential function or logical constraints on top of the graph, to for example guarantee that at most one object per page receives a page number class label. In this case, the confidence model can be either discarded or kept to produce a confidence measure, but is not employed to ensure at most one per page. In other cases, enforcing a requirement that each page has no more than one page number label and no more than one title label is more readily achieved with a separate model 42. For other object classes, such as “section title”, there may be no specified limit, or a different limit, on the maximum and/or minimum number of page labels for a given page class and thus no need to provide for a one per page limit.

A category prediction component 86 predicts, for each plan of the project document 12 (or for each of at least some of the plans), a category, such as, at maximum, a single discipline label 50 corresponding to the plan discipline, using the second CRF model 44. The plan discipline predictions may be based on the page-level label prediction(s), such as the predictions for plan title 46 and plan number 48.

An output component 88 outputs information 90. This may include and/or be based on the page-level predictions, such as the predicted plan title 46, number 48, and discipline 50. The output information 90 may be in the form of an index for the project document 12, which associates each (or at least some) of the plans with a respective plan number, title, and discipline, and or tags, such as XML tags, which identify the locations in the document plan(s) where this information is predicted to be located.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference to FIG. 2, a method for processing a multi-page project document 12 is illustrated, which may be performed with the system of FIG. 1. The method begins at S100.

At S102, trained models 40, 42, 44 are provided. S102 may include training the models 40, 42, 42 using labeled training data 72, with the training component 70, if the models have not yet been generated, or providing previously trained models.

At S104, a multipage project document 12 to be labeled is received.

At S106, the project document 12 is preprocessed by the preprocessing component 80. This includes segmenting the document to generate a set of text blocks 58, 60, etc. for each plan 52, 54, 56. Each page object (e.g., text block) is associated with a set of features, such as location, text content, font style, font size, etc., in the case of text blocks.

At S108, object-level class predictions 83 are jointly predicted for the page objects (e.g., a class is predicted for each text block in the set of text blocks), by the object class prediction component 82, using the first CRF model 40

At S110, for each plan 52, 54, 56, etc., of the project document, page-level labels 46, 48 are predicted, based on the page object predictions 83, made at S108. In the exemplary embodiment, at maximum, a single plan title 46 and a single plan number 48 are predicted, by the page label prediction component 85, using the ranking model 42.

At S112, for each plan of the project document, a category, such as at maximum, a single discipline label 50 corresponding to the plan discipline, is predicted, by the prediction component 86, using the second CRF model 44.

At S114 information 90 is output, by the output component 88, based on the page-level predictions, such as the predicted plan title 46, plan number 48, and plan discipline 50 for each plan in the document.

The method ends at S116.

In the exemplary embodiment, collective classification is used to jointly decide the title and number of all plans of a document. The dependencies of the plan title, number, and discipline are leveraged in identifying the discipline.

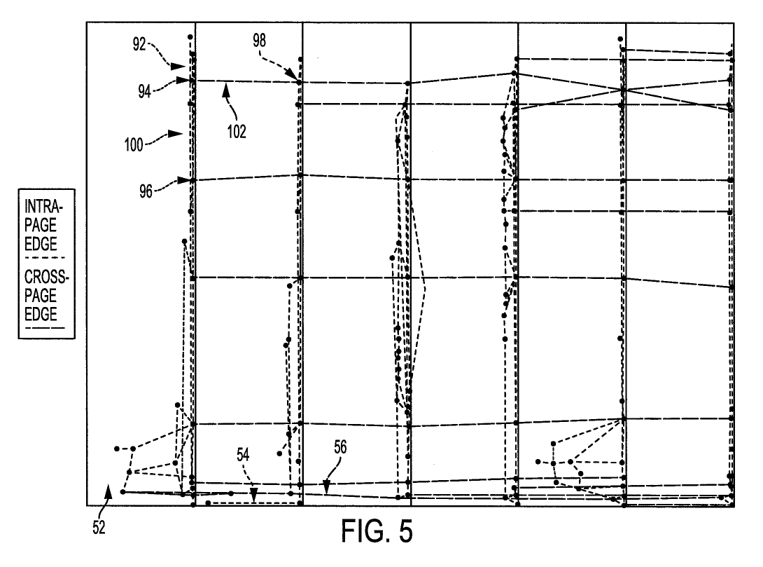

With reference also to FIG. 5, S108 may include the following substeps:

At S200, at least a subset of the identified text blocks 58, 60, etc. of the project document 12 is modeled as a graph 92 in which nodes 94, 96, 98, etc. (shown as circles in FIG. 4) represent text blocks and edges 100, 102, etc. (shown as dashed lines) represent relations between text blocks. The exemplary graph 92 is cyclic (and/or is permitted to be cyclic/not restricted to an acyclic graph).

At S202, feature vectors are computed for the nodes 94, 96, 98, etc., and for the edges 100, 102, etc., based on the respective text block features.

At S204, the classes of the text blocks are predicted with the first prediction model 40.

Further details of the system and method will now be described.

Project plans 52, 54, 56 are often created on Arch E1 paper (30 in×42 in, which is about 76 cm×107 cm) or Arch D paper (24 in×32 in, which is about 61 cm×81 cm). Such plans may be authored by experts in the respective disciplines and can vary considerably in layout and style. The plans may be generated either on paper or in electronic format, e.g., PDF.

Plans on paper are scanned and processed by optical character recognition (OCR). For example, four text directions are supported to identify horizontal and vertically aligned text (left to right, right to left, top to bottom, bottom to top). Eventually, a single digital format is used to represent a plan. This format indicates the position of each character on the page, together with its recognition confidence and some limited typographic information. Characters are grouped in lines. Some or part of the OCR processing may be performed in the preprocessing step (S106).

The training documents 72 may be manually labeled with ground truth data, including the plan title, plan number, and plan discipline. The labels may be at the plan level, and need not identify the actual location on the plan where the information used to generate the plan title and plan number labels occurs. The discipline has no “physical” presence on the page.

### Preprocessing (S106)

The preprocessing of a project document 12, 72 may include reading the document input format, segmenting the textual content of each page to form text blocks, optionally, retaining only the text blocks located in a region of the page where the text blocks relevant to the identification of the plan title and plan number are expected to be found. In an exemplary embodiment, this region 103 (FIG. 4) may be the bottom- and right-margins of the pages. For example, the margin width and height may be about 15% of the page height and width, respectively. Only those text blocks that are entirely or partially within this region 103 are considered.

The reading of the document input format includes extracting the recognized textual content of the page. The recognized text content includes characters from a predefined set of characters (letters, number, punctuation, etc., depending on the application).

Various segmentation approaches are available for identification of text blocks. As an example, the method described in above-mentioned U.S. Pub. No. 20130321867 may be employed. This method finds groups of token elements (characters) by identifying vertically overlapping token elements on different lines of text and considering relatively large white spaces as indicators of the start of a new block. Blocks which contain only graphical elements are ignored.

The segmentation may be designed such that blocks match the granularity of both the title and number of the plans. While it is desirable for the text blocks on a page not to overlap each other, in practice some may overlap.

### Titles and Numbers Joint Prediction (S108)

In step S108, for each text block identified at S106, its label is predicted, which is one of ‘title’, ‘number’ and ‘other’, using the first CRF model 40, which serves as a text block classifier. In this step, a document is modeled as a graph 92 (S200), FIG. 5, where nodes 96, 98, 100 represent text blocks, edges 100, 102 represent relevant relations between text blocks, and where feature vectors are associated with both nodes and edges (S202). The goal is then to collectively predict the class of each node of the document (S204).

1. Graph Generation (S200)

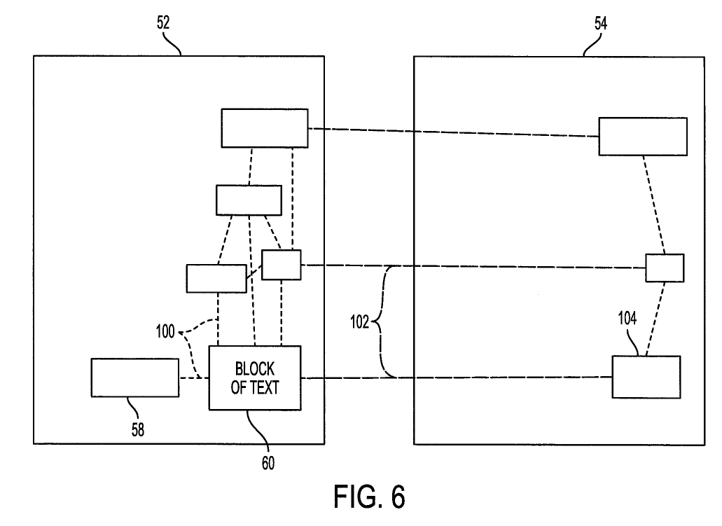

With reference to FIGS. 3 and 6, graph generation (S202) may include the following substeps:

At S300, intra-page edges 100 are identified between pairs of text blocks 58, 60 on the same page.

At S302, cross-page edges 102 are identified between pairs of text blocks 60, 104 on different pages.

At S304, a factor graph 92 is generated for the document in which nodes 96, 98, 100 representing the text boxes 58, 60, 104 are connected by the identified intra-page and cross-page edges 100, 102. Each node of the graph is connected to at least one other node by an edge.

The exemplary CRF classifier 40 models the text blocks of a project document 12 as nodes 94, 96, 98, etc., of an undirected graph G=(X, E), where X={X₁, X₂, . . . , X_{N}} are the nodes of the graph G, and E={(Xᵢ, Xⱼ): i≠j} are undirected edges 100, 102, etc. of the graph, which connect respective pairs of the nodes, as exemplified by graph 92 in FIG. 5. Each node represents a single respective text block. The CRF classifier 40 is input with features of the nodes and features of the edges and jointly classifies the text blocks based on these features. The node location may correspond to the centroid (or other representative point) of the respective block and an edge links two such centroids.

In contrast to existing methods that build only an acyclic graph per page, such as the minimum spanning tree of the page (a tree structure, without loops, where each pair of nodes is connected by no more than one path consisting of one or more edges), the exemplary method builds a graph at the document-level and can be cyclic (i.e., the graph allows loops whereby two nodes can be connected by more than one path). While an MST can be used for connecting intra-page edges, this may not yield as good a performance as allowing cyclic graph paths to exist at both the page level and at the intra-page level, as illustrated in the examples below.

The edges are of two types: intra-page edges, such as edge 100, and cross-page (inter-page) edges, such as edge 102. An intra-page edge connects an intra-page pair of nodes (nodes representing text blocks on the same page of the document). A cross-page edge connects an inter-page pair of nodes (nodes representing text blocks on different pages of the document). The cross-page edges may be limited to connecting nodes appearing on consecutive pages.

The set of edges E represents a filtered subset of the possible set of edges connecting the nodes of the document. First, as noted above, since the extracted blocks may be limited to a specified region 103 of each page, the edges connect pairs of blocks where both blocks lie (at least partially) within these specified regions.

Second, the edges may be filtered to remove the edges which are likely to be less relevant to the predictions, as follows.

i. Identifying Intra-Page Edges (S300)

The intra-page edges 100 reflect a neighboring relationship between two nodes, but may include long distance relationships. Various methods for identifying a subset of such edges are contemplated.

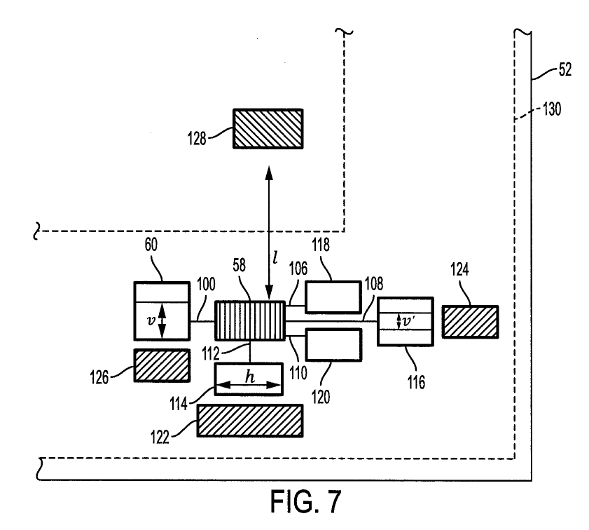

In one embodiment, as illustrated in FIG. 7, for a block under consideration 58, a set of edges 100, 106, 108, 110, 112 may be generated as follows. A horizontal intra-page edge 100 is created where there is a significant and direct vertical overlap v between two horizontally spaced blocks 58, 60. Similarly, a vertical intra-page edge 112 is created where there is a significant and direct horizontal overlap h between two blocks 58, 114. Significant overlap can be defined as exceeding a threshold for a respective overlap length (v or h), e.g., measured in millimetres or point spacing. For example, the overlap threshold may be 2 pt or 0.7 mm. ‘Direct’ means that the two blocks must be in line of sight of each other, i.e., without any obstructing block in between. Thus, for example, the vertical side view of block 116 from block 58 is partially obstructed by blocks 118, 120, leaving an overlap v′ which in this case, is defined by the vertical distance between intervening blocks 118 and 120. There is sufficient vertical overlap in this case, to meet the threshold. For block 122, which is vertically spaced from block 58, no edge is created because there is no direct horizontal overlap between the two blocks due to obscuring block 114. Similarly, there is no direct horizontal or vertical significant overlap with blocks 124, 126. In one embodiment, the limitation of considered blocks to a specified region 103 of the page where relevant blocks are expected to be found (here a lower and right margin region) can be used to exclude some blocks 128 from consideration.

One advantage of this filtering method is that the textual content of a neighboring block can provide useful information for classifying a given block. For example, if the block above contains the string “Plan Title” and is left-aligned with the block of interest, this may be useful for classifying the block of interest as a title block.

The following Algorithm (Algorithm 1) may be used to identify the set of intra-page edges.

### Algorithm 1

1. Identify vertical and horizontal edges of the blocks (this can be done with the same algorithm, identifying a set of (e.g., vertical) edges, rotating the page 90°, and identifying the remaining (horizontal) block edges.

2. For computing vertical edges:
a. Sort the blocks by their y₁ values, where (x₁, y₁) are the top-left corner coordinates and (x₂, y₂) are the bottom-right coordinates.
b. Build an index, which given a y₂ value, returns the index, in the sorted block list, of the first block whose y₁ is larger than y₂.
c. Start with one of the top-most blocks:
   i. Given its y₂, use the index to get the (x₁, x₂) of each of the blocks below it.
   ii. Enumerate them, ignoring the ones that are hidden by neighbors.
   iii. Generate a vertical edge from the considered block to each block that meets the direct and significant overlap constraints (and optionally the distance constraint).
   iv. return to c(i) and repeat c(i)-(ciii) for next-highest block, until the penultimate block has been processed.

3. For computing horizontal edges;
a. Sort the blocks by their x₁ values.
b. Build an index, which given a x₂ value, returns the index, in the sorted block list, of the first block whose x₁ is larger than x₂.
c. Start with one of the left-most blocks:
   i. Given its x₂, use the index to get the (y₁, y₂) of the blocks to the right of it.
   ii. Enumerate them, ignoring the ones that are hidden by neighbors.
   iii. Generate a horizontal edge from the considered block to each block that meets the direct and significant overlap constraints (and optionally the distance constraint).
   iv. return to c(i) and repeat c(i)-(ciii) for next-leftmost block, until the penultimate block has been processed.

4. Repeat for next page until all pages are processed.

5. Output set of intra-page edges for document.

Other techniques may be used for identifying the set of intra-page edges. In some embodiments, a double watermark technique may be used to speed-up the computation of direct line of sight. For example, as illustrated in FIG. 7, when block 118 has been identified as meeting the direct horizontal line of sight criteria for block 58, the height of block 58 is reduced, by the extent of vertical overlap with block 118, for purposes of computing subsequent (in the sorted list) horizontal edges for this block. Similarly, when block 114 has been identified as meeting the direct vertical line of sight criteria for block 58, the width of block 58 is reduced, by the extent of horizontal overlap, for purposes of computing subsequent vertical edges for this block. In this latter example, the width of block 58 is reduced to zero since blocks 58 and 114 are left and right aligned, so no further blocks need to be considered at this step.

In some embodiments, edges may be limited to a maximum length l. In this embodiment, no edge is created with block 128, even though it is directly overlapping, since it exceeds the threshold length l.

ii. Identifying Cross-Page Edges (S302)

Cross-page edges assist in capturing positional regularities among blocks of consecutive plans in a document.

To create the cross-page edges 102, etc., consecutive pages are superposed pairwise (such that their borders are aligned). An edge is created whenever two blocks, one from each page, with same text orientation, significantly overlap each other after superposition, i.e., have at least a threshold overlap. The overlap may be computed as the ratio of the area of intersection to the area of the union of both blocks. The overlap threshold may be, for, example, below 0.5, or below 0.4, such as at least 0.1, or at least 0.2, or 0.25.

This type of relationship is useful as the position on the plan of the title, number, or other particular elements is often consistent for at last a part of the document.

iii. Generating the Graph (S304)

FIG. 5 shows the resulting graph 92 for a six-page document, in which the intra-page edges 100 and cross-page edges 102 connect respective pairs of nodes (pages not to scale). A single point in a two-dimensional space is used to represent each node and a line is used to represent an edge connecting a pair of nodes, for each of the identified edges. As will be appreciated, the graph 92 can be stored in memory 14 as any suitable data structure, which captures the node and edge information.

2. Feature Extraction (S202)

A feature vector is extracted for each node and for each edge of the graph 92.

The node feature vectors may include a set of spatial features and a set of textual features. Examples of spatial features include:

Node location, e.g., a set of coordinates and/or width and height, such as: x₁, y₁, w, h;

Examples of textual features which may be used include some or all of:
Lowercase characters are included in text;
Lowercase characters only are used in text;
Titlecase characters are used in text;
Uppercase characters only are used in text;
Alphanumeric characters are used in text;
Alphabetical characters only are used in text;
Digits only are used in text;
Node text is encapsulated in brackets;
Node text length;
Node text orientation (four possible text directions);
Term frequency-inverse document frequency (tf-idf) of the identified words computed at a page level;
tf-idf of identified words computed at the document level;
Inverse document frequency (idf) normalized over a range, such as [0, 1];
character n-grams.

For the character n-gram features, a set of n-grams is identified from similar documents, such as the document collection 72, e.g., based on tf-idf. This can be used to produce a relatively small set of n-grams, such as from 100 to 10,000 n-grams, or up to 2000 or 1000 n-grams, to be used as features. n can be a number such as from 1-6, or at least 2. Different sizes of n-grams can be considered. Each feature corresponds to a respective one of the set of n-grams and may have a binary value indicating whether the n-gram is present or not, or in other embodiments, is representative of the number of that n-gram in the text block. n-grams may also be considered at the word level rather than at the character level, although this may be less useful due to the small number of words in the text string in a given block.

The edge features may include features that are based on the features of the two nodes that they connect, such as a concatenation of some or all of the spatial and textual features defined above. Additionally, since intra- and cross-page edges are different in nature, the edge feature vector may include one set of features reserved for intra-page edges, and another set for cross-page edges. This allows the CRF model 40 to learn different weights for different aspects of the edges.

The edge feature vectors may thus be composed of 5 sets of features:

a. “intrinsic” features: type of edge (3 features to 1-hot encode vertical vs horizontal vs cross-page edges).

b. For cross-page edges: N textual features of node 1 and node 2 (for intra-page edges, these features are N zeros).

c. For cross-page edges: N′ features related to the pair of nodes: spatial relation (centered, left aligned, right aligned . . . ), typographic (font size ratio or difference), sequential features, common substring lengths, etc. (N′ zeros otherwise).

d. For intra-page edges, the same features as in b) (N zeros otherwise).

e. For intra-page edges, same features as in c) (N′ zeros otherwise).

Examples of such features include:
source and target node texts form a possible sequence (−1 means in reverse direction) [−1, 0, 1 (3 features)];
source and target node texts form a possible sequence in either direction [0, 1] (1 feature)
source and target nodes are:
   horizontally centered; vertically centered; left-aligned; top-aligned; right-aligned; bottom-aligned; equal source and target text; (1 feature each)
   source text is: alphanumeric, alphabetical, lowercase, title, uppercase; (1 feature each)
   target text is: alphanumeric, alphabetical, lowercase, title, uppercase; (1 feature each)
edge geometry: (2×7 features)
   if vertical or horizontal edges (i.e., intra-page edges), then 7 zeros and 7 features, else 7 features and 7 zeros, features being: overlap surface of source and target, normalized on [0, 1]; overlap surface of source and target bounded by 5000; LCS of source and target text, normalized on [0, 1]; LCS bound by 50; LCS bound by 100; font size difference; font size ratio (fzS+1)/(fzT+1)
n-grams, 500 features for each type:
   character n-grams of SOURCE node text if INTRA-page edge;
   character n-gram of SOURCE node text if CROSS-page edge;
   character n-grams of TARGET node text if INTRA-page edge; and
   character n-grams of TARGET node text if CROSS-page edge.

Where page objects other than text blocks are contemplated, other features may be extracted. In one embodiment, a feature may be used to indicate whether the page object is textual, image, vector graphics, or table. For each type of page object, a respective set of features may be extracted (which are set to zero if the object is not of that type. Thus, for example, image features may include features extracted from pixels or patches of the image, or features of a representation thereof, such as a Fischer vector, bag-of-visual words representation, or neural network representation, as described, for example, in U.S. Pub Nos. 20120076401 and 20120045134 and U.S. Ser. No. 14/793,434, filed Jul. 7, 2015, entitled EXTRACTING GRADIENT FEATURES FROM NEURAL NETWORKS, by Albert Gordo Soldevila, et al.

### Training the First CRF Model (S102)

The CRF model 40 is trained on node and edge feature vectors extracted from the collection of training documents 72 (extracted in the same manner as for the project document 12) and respective page labels (which may each be associated with the most probable block). In the training stage, a respective graph 92 may be generated for each of the training documents 72.

The model 40 learns a weight for each of the features. The learning aims to optimize (e.g., minimize) a graph energy function, which may a combination of a node potential function and a pairwise potential function (for the edges).

The exemplary CRF model 40 includes a first vector of weights per node class, each including one weight per node feature, for the node potential function, and a second vector of weights per pair of node classes, each including one weight per edge feature for the pairwise (edge) potentials. The training step learns the weights so as to maximize the overall potential on the training set, given certain regularization constraints.

The graph energy function may be of a general form that is commonly used in structured prediction:

$${y}^{*} = {arg max}_{y ∈ Y} f ( x , y )$$

where x is the input graph (a set of nodes and edges), Y is the set of all possible outputs (an output is the labeling of the nodes of the graph) and f is a compatibility function that says how well a given graph labeling y fits the input graph x. The graph x is represented by node and edge feature vectors, and edge definitions (a pair of nodes). The prediction for x is y*, the element of Y that maximizes the compatibility. See, Andreas Mueller, Andreas Mueller, “Pystruct 0.2-What is structured learning,” 2013, accessible at https://pystruct.github.io/intro.html#intro.

The learning may be achieved using a one slack structured SVM algorithm. (See, Thorsten Joachims, et al., “Cutting-plane training of structural SVMs,” JMLR 77(1): pp 27-59, 2009; Andreas Mueller, “Methods for Learning Structured Prediction in Semantic Segmentation of Natural Images,” PhD Thesis. 2014; Andreas Mueller, et al., “Learning a Loopy Model For Semantic Segmentation Exactly,” VISAPP, pp. 1-8, 2014).

In one exemplary embodiment, described in the examples below, the CRF model 40 is learned using the PyStruct library (pystruct.models.EdgeFeatureGraphCRF, available at pystruct.github.io/generated/pystruct.models.EdgeFeatureGraphCRF.html) and pystruct.learners.OneSlackSSVM, available at pystruct.github.io/generated/pystruct.learners.OneSlackSSVM.html).

Identifying the form and parameters of the function f and solving the argmax function can be performed with the PyStruct algorithm, which assumes f to be a linear function of some parameters w and a joint feature function of x and y:

f(x, y)=w^{T}joint_feature(x, y)

Here w are parameters that are learned from data, and joint_feature is defined by the user-specified structure of the model. PyStruct assumes that y is a discrete vector, and most models in PyStruct assume a pairwise decomposition of the energy f over entries of y, that is:

f(x, y)=w^{T}joint feature(x, y)=Σ_{i∈V}wᵢ^{T} joint_featureᵢ(x, yᵢ)+Σ_{i,j∈E}w_{i,j}^{T} joint_featureᵢ(x, yᵢ, yⱼ)

Here V are a set of nodes corresponding to the entries of y, and E are a set of edges between the nodes.

The output of the training of the CRF model 40 is the set of weights wᵢ (one weight for each element of the node feature vectors) and the set of weights w_{i,j} (one weight for each element of the edge feature vectors).

Prediction of Classes for Blocks with the Trained First CRF Model (S204)

Given the graph 92, the CRF model 40 predicts the optimal set of block class labels 83 for optimizing the learned graph potential function. Prediction may entail computing an argmax function, i.e., finding the labeling of the nodes in the graph that maximizes the graph potential function used in the learning stage, given the feature vectors of the nodes and edges and the learned weights wᵢ and w_{i,j}. The label prediction can be performed, for example, by Alternating Directions Dual Decomposition (AD³). See, for example, André F. T. Martins, et al., “AD³: Alternating Directions Dual Decomposition for MAP Inference in Graphical Models,” Journal of Machine Learning Research, 16 (1), pp. 495-545, 2015; André F. T. Martins, et al., “Augmenting dual decomposition for MAP inference,” Proc. Int'l Workshop on Optimization for Machine Learning (OPT), pp. 1-6 (2010); and the AD³ dual decomposition website at http://www.cs.cmu.edu/-ark/AD3/.

### Prediction of Page Title and Number (S110)

In this step, the aim is to enforce a constraint that each page has at most one label for each page-level class, such as one plan title 46 and one plan number 48. As will be appreciated, step S108 may result in more than one block being assigned to the title class (or number class) on a given page of the project document. Collective classification is used to jointly infer the title and number of all plans of a document.

S110 may include predicting, for each plan number and plan title text block identified at S108, a confidence-level with respect to the assigned class. The confidence level may be output, to allow a user of the system to manually assess the basis of the plan title/plan number prediction. The confidence score can also be used in an automatic manner, for ensuring a certain quality level: any label whose confidence is below a certain threshold is automatically discarded. This is advantageous if the absence of a label is less of a problem than a wrong label. To enforce the constraint of having at most one title and one number label per plan, a separate classifier model 42 is trained and its confidence scores are used for ranking the candidate plan number and plan title text blocks. The training of the classifier 42 may be performed, for example, using logistic regression. The classifier 42 may be a multi-class node classifier, which may be trained using some or all of the node features previously computed on the labeled training set 72 for learning the first CRF classifier 40. For example, n-gram features are extracted from the text blocks having a class which is page title or page number.

The model 42 may be learned using features of those blocks of the training documents which correspond to the actual plan title and plan number, as positive examples for each label, and may use features of other blocks as negative training samples for each label.

When input with the node features of a page to be labeled, the trained model 42 computes a confidence score for each block with respect to one or more object class, and/or identifies the highest scoring blocks for the classes (plan title and plan number) for each page. The text of these two blocks is predicted to correspond to the plan title and plan number, respectively. The confidence score may be computed independently for each text block, without considering other text blocks. In another embodiment, features of neighboring text blocks that are connected by an edge may be considered. For example, text of a set of nearest text blocks, or of text blocks within a threshold distance, may be concatenated with that of the considered block and used for generation of the confidence score. The set of neighboring text blocks may be selected from the same page, from cross-pages, or both (see Logit1 and Logit2 models in the Examples).

In the case where the labeling of the training documents 72 does not specify the text blocks corresponding to the actual plan title and plan number, but only provides a plan title and plan number for each page, the blocks of the training documents may be automatically searched to identify the blocks which are most similar to the ground truth labels, for example, by computing an edit distance or other similarity measure. This is also useful in the case where a manual annotator labels the documents with titles and page numbers that do not exactly correspond to that on the page itself, e.g., through typographical errors (either introduced by the annotator, or correcting an observed error), abbreviations (e.g., replacing “and” with &, or vice versa), use of different numbering formats (e.g., E-11 instead of E11) and the like.

The model 42 may be learned with any suitable classifier training method, such as logistic regression, support vector machines (SVM), or the like. In the case of logistic regression, for example, the method includes learning weights of a function which takes as input the features of a text block and outputs a score for each class of relevance (plan title and plan number).

In the examples below, the scikit learn linear logistic regression model is used in this step (see, http://scikit-learn.org/stable/modules/generated/sklearn.linear_model.LogisticRegression.html) However, any classification model providing a confidence level can be employed.

### Predicting Plan Discipline (S112)

While the plan discipline 50 may be predicted as part of the CRF classification step (S108) using the first CFR model 40, in practice, higher performance can be achieved when the plan discipline is inferred after the plan title 46 and plan number 48 have been predicted. There is often some sequential relationship between the plan disciplines of a sequence of pages. For example, the plan number of a “electrical” plan may be “E-2” while the title could be “Electrical Schema—floor 2”, and if the next plan also belong to the electrical discipline, its plan number may well be “E-3” and placed at a similar position to “E-2”. A sequential prediction model 44, such as a linear chain CRF model, may therefore be employed to predict the discipline of the plans collectively, given a document. The regularity in the disciplines of a sequence of plans can thus be leveraged by the chain CRF, which uses the prediction for one page in prediction of the discipline of the next page, and so forth. In one embodiment, the prediction is based solely on the predicted plan titles and plan numbers of the respective pages, although other features may also be employed.

Chain CRF models suitable for use herein are described, for example, in Sutton, et al., “An Introduction to Conditional Random Fields,” arXiv:1011.4088v1 [stat.ML], 17 Nov. 2010 (see, section 2.3). Given input data, the chain CRF model 44 proceeds through a sequence of steps each depending on outputs of the prior step.

The second CRF model 44 may be learned using the ground-truth category (e.g., discipline) labels, provided by the annotator, and features of the text blocks identified as corresponding to the object classes (plan titles and plan numbers) of each page by the learned prediction model 42. In another embodiment, the object classes predicted for these blocks may be used. The learning assigns weights to features of a feature function which relates the category label 50 to the relevant block features for the current and the previous page, and the page label prediction(s) 46, 48 of the previous page(s)).

When input with the predicted plan title and plan number 46, 48 (and/or the features of the corresponding highest scoring text blocks) for each of a sequence of document plans of a project document 12, the learned second CRF model 44 outputs, in one embodiment, at most one predicted category per page. In other embodiments, the model 44 may be configured to predict more than one category, such as from zero to a maximum number of categories, such as no more than two, three or more categories.

At S114 the plan title, number and discipline labels for each page of the project document are output and may be used for generating a table of contents (TOC) for the document. Tags, such as hyperlinks may be provided to enable users to click on an entry in the TOC to be taken to the relevant page. Document searching by plan title, plan number, and/or discipline may be enabled.

The system and method described differ from existing methods in that a document understanding task is addressed using a conditional random field/factor graph, at the document-level. The document is considered as a sequence of 2D spaces containing objects to be identified. Articulating the task in this way leads to distinguishing cross- and intra-page edges.

The method illustrated in FIGS. 2 and 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 32, (for example, an internal hard drive of RAM), or may be separate (for example, an external hard drive operatively connected with the computer 32), or may be separate and accessed via a digital data network such as a local area network (LAN) or the Internet (for example, as a redundant array of inexpensive or independent disks (RAID) or other network server storage that is indirectly accessed by the computer 32, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2 and/or 3, can be used to implement the method. As will be appreciated, while the steps of the method may all be computer implemented, in some embodiments, one or more of the steps may be at least partially performed manually. As will also be appreciated, the steps of the method need not all proceed in the order illustrated and fewer, more, or different steps may be performed.

Without intending to limit the scope of the exemplary embodiment, the following examples illustrate the application of the method.

### EXAMPLES

### 1. Ground Truth Data

A collection of 26.000 project plans was obtained in four sets, as shown in TABLE 1.

TABLE 1
Data sets

| Set | No. of documents | No. of pages |
|---|---|---|
| 1 | 40 | 6312 |
| 2 | 71 | 8597 |
| 3 | 15 | 5524 |
| 4 | 29 | 5306 |
| TOTAL | 155 | 25739 |

The ground truth information takes the form of a normalized plan title, a normalized plan number, and a discipline per plan, e.g., in the form: <PAGE number=“2” type=“A” pnum=“D1.1” title=“DEMOLITION PLAN”/>. This page ground truth was first projected onto the text blocks of the respective page. The ground truth is noisy and incomplete, however. In particular, the following issues were observed:
Some plan numbers were interpreted by the annotator instead of exactly reproducing what was on the plan. For example the annotator may provide a page number annotation “1OF20” while on the plan a “1” appears in a table cell and in the next table cell a “20”.
When a plan number occurs multiple times, the annotator adds an extra character: an ‘A’ is appended the first time, then a ‘B’, etc.
Some pages have a sheet number, others a plan number, and some pages have both. Annotators seem to indicate a sheet number in the absence of plan number.
Titles are normalized and truncated to 51 characters if longer than 50 characters.
OCR or PDF extraction problems were also observed:
   the input text original segmentation is unreliable. (TOKENs are identified well, but LINEs are not),
   common character confusion occurs: O/0, I/1, I/1, ,/.
   extra characters, e.g., “A5.11” is recognized as “A5.11I” (e.g., due to a ruling line),
   some glyphs are missed entirely.

For plan numbers, only between 72% and 83% of the human annotation were able to be projected automatically on to text blocks. For plan title, between 68% and 73% of the human annotations were projected. However, this proved sufficient data for implementing the method. With a set of rules built to identify some of the potential errors, or more accurate annotations, improved results could be expected.

### Example 1

### Comparison of Different Methods of Prediction of Page Title and Page Number Labels

The following methods were compared:

1. Simple Logit: a multi-class (Title, Number, Other) logistic regression model is trained using the features of the nodes but not the edges. Features={F(node)}

2. Logit1: the node features vector is extended with the n-grams of the union of the text of the neighbor nodes (here, neighbor means connected by an edge). Features={F(node)+F(node_neighbor)}

3. Logit2: similar to Logit1, but the features of the same-page neighbors are separated from the cross-page ones, extending Simple Logit with 2 additional vectors. Features={F(node)+F(node_same_page_neighbor)+F(node_cross_page_neighbor)}

4. Collective labeling (CL): The present method, using two CRF models 40, 44 and a logistic regression ranking model 42.

Example features used included those described above. In total, 1218 node features and 2059 edge features were used, including n-gram features for n=2 and n=6. The models were trained using datasets 2, 3, and 4 and were tested on dataset 1. With the 3 training sets, training of the present CL system lasted 56 hours and occupied 250 GB RAM. From the 116 documents, a graph including 1,805,753 nodes and 3,941,189 edges was generated. Prediction is extremely fast as the time constraint is the loading of the XML document from the hard-disk.

Performance was measured as precision (P), recall (R), and F1 (F) measure on the extracted plan titles, plan number, and plan discipline. Results are shown in TABLE 2, where nOK is the number of correctly labeled pages, nError is the total number of pages with a labeling error (one or more incorrect labels) and nMiss is the total number of pages missing a correct label (i.e., pages with no label or an incorrect label).

TABLE 2
Results for different labeling systems

| | | | | | |
|---|---|---|---|---|---|
| P | R | F | nOK | nError | nMiss |

PLAN NUMBER

| | | | | | | |
|---|---|---|---|---|---|---|
| Simple Logit | 71 | 61 | 65 | 3839 | 1593 | 2483 |
| Logit1 | 73 | 63 | 68 | 4002 | 1449 | 2320 |
| Logit2 | 77 | 67 | 71 | 4201 | 1279 | 2121 |
| CL | 90 | 81 | 85 | 5094 | 548 | 1228 |

PLAN TITLE

| | | | | | | |
|---|---|---|---|---|---|---|
| Simple Logit | 67 | 57 | 62 | 3620 | 1788 | 2702 |
| Logit1 | 81 | 67 | 73 | 4202 | 990 | 2120 |
| Logit2 | 84 | 69 | 76 | 4373 | 810 | 1949 |
| CL | 84 | 74 | 79 | 4689 | 875 | 1633 |

PLAN DISCIPLINE

| | | | | | | |
|---|---|---|---|---|---|---|
| Simple Logit | 80 | 80 | 80 | 5036 | 1286 | 1286 |
| Logit1 | 81 | 81 | 81 | 5127 | 1195 | 1195 |
| Logit2 | 84 | 69 | 76 | 4373 | 810 | 1949 |
| CL | 84 | 84 | 84 | 5325 | 997 | 997 |

The results suggest that the exemplary method with collective labeling (CL) and cross-page edge information outperforms the other methods. Using information from neighboring nodes, as well as distinguishing same-page from cross-page neighbors, is advantageous.

### Example 2

### Evaluating Aspects of the Exemplary Method

A series of experiments was performed to evaluate the value of certain aspects.

A. Value of Intra-Page and Cross-Page Edges

Two aspects were evaluated: 1) the effect of removing the intra-page or cross-page edges from the graph; 2) the effect of not distinguishing intra-from cross-page edges (i.e., if they share the same weight vector in the model).

In this evaluation, datasets 2, 3, and 4 were used for training and dataset 1 for testing, with same features as for Example 1. TABLE 3 shows the results obtained.

TABLE 3
Edge Effects

| | | | | | | |
|---|---|---|---|---|---|---|
| Method | P | R | F | nOK | nError | nMiss |

PLAN NUMBER

| | | | | | | |
|---|---|---|---|---|---|---|
| CL (intra- and cross-page edges | 90 | 81 | 85 | 5094 | 548 | 1228 |
| that are distinguished from each | | | | | | |
| other) | | | | | | |
| No intra-page edge | 86 | 79 | 82 | 4992 | 807 | 1330 |
| No cross-page edge | 88 | 80 | 84 | 5052 | 724 | 1270 |
| Both intra- and cross-page, but | 91 | 81 | 85 | 5087 | 534 | 1235 |
| undistinguished from each other | | | | | | |

PLAN TITLE

| | | | | | | |
|---|---|---|---|---|---|---|
| CL (intra- and cross-page edges | 84 | 74 | 79 | 4689 | 875 | 1633 |
| that are distinguished from each | | | | | | |
| other) | | | | | | |
| No intra-page edge | 82 | 73 | 77 | 4581 | 982 | 1741 |
| No cross-page edge | 83 | 73 | 78 | 4611 | 972 | 1711 |
| Both intra- and cross-page, but | 84 | 74 | 79 | 4668 | 898 | 1654 |
| undistinguished from each other | | | | | | |

PLAN DISCIPLINE

| | | | | | | |
|---|---|---|---|---|---|---|
| CL (intra- and cross-page edges | 84 | 84 | 84 | 5325 | 997 | 997 |
| that are distinguished from each | | | | | | |
| other) | | | | | | |
| No intra-page edge | 83 | 83 | 83 | 5237 | 1085 | 1085 |
| No cross-page edge | 83 | 83 | 83 | 5266 | 1056 | 1056 |
| Both intra- and cross-page, but | 83 | 83 | 83 | 5270 | 1052 | 1052 |
| undistinguished from each other | | | | | | |

The results suggest that distinguishing between cross-page and intra-page edges gives an improvement over the other methods, and that removing either intra- or cross-page edges worsens the results. These conclusions were also drawn from results obtained when training only on dataset 2, where the benefits of distinguishing between cross-page and intra-page edges was even more marked.

B. Value of Neighboring Edges

In existing methods described in the literature, a simple structure reflecting the document as a whole (e.g., the document as a list of sentences), or at a page-level has been used. In the latter case, a minimum spanning tree (MST) is generally created to reflect the objects placed on the 2D space. This removes any loop from the graph and thus different training and inference algorithms are applicable.

In the present method, loops are needed to reflect the cross page edges, even though the page layout can be represented using MSTs. An evaluation in which MST is used at the page-level and cross-page edges with loops was performed.

In this evaluation, training was performed on dataset 2 and testing on dataset 1. Results are shown in TABLE 4.

TABLE 4
Neighbor Effects

| | | | | | | |
|---|---|---|---|---|---|---|
| Method | P | R | F | nOK | nError | nMiss |

PLAN NUMBER

| | | | | | | |
|---|---|---|---|---|---|---|
| CL | 89 | 80 | 84 | 5050 | 615 | 1272 |
| page-level MST | 85 | 79 | 82 | 5000 | 913 | 1322 |

PLAN TITLE

| | | | | | | |
|---|---|---|---|---|---|---|
| CL | 80 | 71 | 75 | 4486 | 1120 | 1836 |
| page-level MST | 78 | 69 | 73 | 4335 | 1216 | 1987 |

PLAN DISCIPLINE

| | | | | | | |
|---|---|---|---|---|---|---|
| CL | 80 | 80 | 80 | 5059 | 1263 | 1263 |
| page-level MST | 78 | 78 | 78 | 4951 | 1371 | 1371 |

The results suggest that the exemplary method of reflecting the 2D relationships between page elements which allows cycles to exist at the page level is better than an MST.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for processing a multi-page document comprising:
providing a trained first model for jointly predicting class labels for page objects of pages of a document, the predicted class labels being selected from a predefined set of class labels;
receiving a multi-page document to be labeled;
generating a graph in which page objects extracted from pages of the multi-page document are represented by nodes that are connected by edges, the nodes and edges of the graph each being associated with a set of features, the edges including intra-page edges and cross-page edges;
with the trained first model, jointly predicting object class labels from the set of class labels for at least some of the represented page objects, the prediction being based on the sets of features of the nodes and edges; and
outputting information based on the predicted object class labels,
wherein at least one of the generation of the graph and predicting object class labels is performed with a processor.

2. The method of claim 1, wherein the first model is a conditional random field model.

3. The method of claim 1, wherein the set of features for each edge of the graph includes features derived from features of the pair of nodes connected by the edge.

4. The method of claim 1, wherein the set of features for each edge of the graph distinguishes between an intra-page edge and a cross-page edge.

5. The method of claim 1, wherein the set of features for each node of the graph includes spatial features for the respective represented page object.

6. The method of claim 1, wherein the page objects comprise text blocks.

7. The method of claim 6, wherein the set of features for each node of the graph includes textual features for the respective represented text block.

8. The method of claim 1, wherein the set of class labels comprises a page title class label, a page number class label, and optionally another class label.

9. The method of claim 1, further comprising predicting, for each page of at least some of the pages of the input document, a page label, based on the predicted object class labels.

10. The method of claim 9, wherein the predicting page labels, includes for each page of the input document, predicting a maximum of a single page title and a maximum of a single page number, and wherein the output information is based on the predicted page titles and page numbers of pages of the input document.

11. The method of claim 10, wherein the predicting, for each page of the input document, at maximum, a single page title and a single page number is performed with a classifier model that has been trained using features of page objects labeled with at least one of a page title and a page number class label, drawn from a collection of training documents in which pages of the training documents are labeled with a respective page title label and a page number label.

12. The method of claim 1, wherein the providing of the trained first model includes learning the first model using a collection of multi-page training documents in which at least some of the pages are labeled with a single page title and a single page number.

13. The method of claim 1, further comprising segmenting the input document to extract a set of page objects for each page and associating each page object with a set of features.

14. The method of claim 1, wherein the intra-page edges each link a pair of nodes on a same page of the input document and the cross-page edges each link a pair of nodes on different pages of the input document.

15. The method of claim 1, wherein the generating of the graph includes at least one of:
identifying a set of intra-page edges, including iteratively filtering an ordered set of candidate edges linking a considered page object to other page objects of a same page of the input document to remove candidate horizontal edges to others of the page objects that lack a threshold amount of vertical overlap with the considered page object and to remove candidate vertical edges to others of the page objects that lack a threshold amount of horizontal overlap with the considered page object, wherein the vertical overlap is computed based on a vertical dimension of the considered block, reduced by vertical overlap of any previously considered horizontally aligned block, and wherein the horizontal overlap is computed based on a horizontal dimension of the considered block, reduced by horizontal overlap of any previously considered vertically aligned block; and
identifying a set of cross-page edges including identifying a pair of page objects on two consecutive pages wherein, when the consecutive pages are superimposed, the page objects in the pair have at least a threshold overlap, and generating an edge which links the identified pair of page objects.

16. The method of claim 1, further comprising providing a trained second model for predicting a page categories from a predefined set of page categories, based on features of the page objects of pages of a document that are predicted to correspond to a page title or a page number and, with the trained second model, predicting, for each page of the input document, at maximum, a single page discipline from the set of page disciplines, and wherein the outputting information is also based on the predicted page disciplines of pages of the input document.

17. The method of claim 16, wherein the second model comprises a sequential conditional random field model.

18. The method of claim 16, further comprising training the second model on predicted page titles and page numbers of pages of each of a collection of training documents, the predicted page titles and page numbers being predicted based on predicted class labels for page objects of the set of training documents output by the trained first model.

19. The method of claim 1, wherein the input document is a project document and the pages each correspond to a document plan.

20. The method of claim 1, wherein the output information includes at least one of:
an index for the input document which includes the predicted page titles and page numbers; and
a modified input document in which pages of the document include tags that identify at least one of predicted page titles and predicted page numbers.

21. A computer program product comprising a non-transitory recording medium storing instructions, which when executed on a computer, causes the computer to perform the method of claim 1.

22. A system comprising memory which stores instructions for performing the method of claim 1 and a processor in communication with the memory for executing the instructions.

23. A system for processing a multi-page document comprising:
a graphing component which generates a graph in which page objects extracted from pages of a multi-page input document are represented by nodes that are connected by edges, the nodes and edges of the graph each being associated with a set of features, the edges including intra-page edges and cross-page edges;
an object class label prediction component with access to a trained first model, stored in memory, for jointly predicting object class labels for page objects of the pages of the input document, based on the graph;
optionally, a page class label prediction component which computes a confidence score for page objects with respect to the page object class labels, and for pages of the input document, assigns a respective at least one page label, based on the confidence scores;
optionally, a category prediction component, with access to a trained second model, stored in memory, which predicts, for pages of the input document, a respective category from a predefined set of categories, based on at least one of the predicted object class labels and predicted page labels;
an output component which outputs information, based on the predicted page labels of pages of the input document; and
a processor which implements the components.

24. A method for generating a system for processing a multi-page document comprising:
with a processor, training a first model for jointly predicting class labels for text blocks of pages of a document, the predicted class labels being selected from a predefined set of class labels including a page title label and a page number label using a cyclic graph generated for the document and storing the first model in memory;
providing instructions in memory for generating the cyclic graph in which text blocks extracted from pages of the multi-page document are represented by nodes that are connected by edges, the nodes and edges of the graph each being associated with a set of features, the edges including intra-page edges and cross-page edges;
providing instructions in memory for predicting, for each page of the input document, a maximum of a single page title and a maximum of a single page number; and
with a processor, training a second model for predicting discipline labels for pages of the document, based on the predicted page titles and page numbers for the document, and storing the second model in memory; and
providing instructions for outputting information based on the predicted page titles, page numbers, and discipline labels of the pages of the document.
